(19) United States
(12) Patent Application Publication
(10) Pub. No.: US 2025/0103707 A1
(43) Pub. Date: Mar. 27, 2025

(54) PROTECTION OF DATA BASED ON OPERATIONS TO ACCESS CONTENT ON MEMORY DEVICES

(71) Applicant: Micron Technology, Inc., Boise, ID (US)

(72) Inventors: Sourin SARKAR, Bangalore (IN); Kiran K. GUNNAM, Cedar Park, TX (US); Chittoor Ranganathan PARTHASARATHY, Hyderabad (IN)

(21) Appl. No.: 18/781,301

(22) Filed: Jul. 23, 2024

Related U.S. Application Data
(60) Provisional application No. 63/584,697, filed on Sep. 22, 2023.

(51) Int. Cl. G06F 21/55; G06F 21/60; G06F 21/78

(52) U.S. Cl. CPC G06F 21/554; G06F 21/604; G06F 21/78

(57) ABSTRACT

In some implementations, a memory device may include one or more components. The one or more components may be configured to identify an operation to access content stored in a memory of the memory device, wherein the operation is associated with a user profile. The one or more components may be configured to flag a user, associated with the user profile, as being potentially malicious based on the operation conflicting with a past content access pattern associated with the user profile. The one or more components may be configured to lock the memory based on the user being flagged.

### CROSS-REFERENCE TO RELATED APPLICATION

This Patent application claims priority to U.S. Provisional Patent Application No. 63/584,697, filed on Sep. 22, 2023, entitled “PROTECTION OF DATA BASED ON OPERATIONS TO ACCESS CONTENT ON MEMORY DEVICES,” and assigned to the assignee hereof. The disclosure of the prior Application is considered part of and is incorporated by reference into this Patent Application.

### TECHNICAL FIELD

The present disclosure generally relates to memory devices, memory device operations, and, for example, protection of data stored on memory devices based on user behavior awareness.

### BACKGROUND

A non-volatile memory device, such as a NAND memory device, may use circuitry to enable electrically programming, erasing, and storing of data even when a power source is not supplied. Non-volatile memory devices may be used in various types of electronic devices, such as computers, mobile phones, or automobile computing systems, among other examples.

A non-volatile memory device may include an array of memory cells, a page buffer, and a column decoder. In addition, the non-volatile memory device may include a control logic unit (e.g., a controller), a row decoder, or an address buffer, among other examples. The memory cell array may include memory cell strings connected to bit lines, which are extended in a column direction.

A memory cell, which may be referred to as a “cell” or a “data cell,” of a non-volatile memory device may include a current path formed between a source and a drain on a semiconductor substrate. The memory cell may further include a floating gate and a control gate formed between insulating layers on the semiconductor substrate. A programming operation (sometimes called a write operation) of the memory cell is generally accomplished by grounding the source and the drain areas of the memory cell and the semiconductor substrate of a bulk area, and applying a high positive voltage, which may be referred to as a “program voltage,” a “programming power voltage,” or “PPV,” to a control gate to generate Fowler-Nordheim tunneling (referred to as “F—N tunneling”) between a floating gate and the semiconductor substrate. When F—N tunneling is occurring, electrons of the bulk area are accumulated on the floating gate by an electric field of VPP applied to the control gate to increase a threshold voltage of the memory cell.

An erasing operation of the memory cell is concurrently performed in units of sectors sharing the bulk area (referred to as “blocks”), by applying a high negative voltage, which may be referred to as an “erase voltage” or “Vera,” to the control gate and a configured voltage to the bulk area to generate the F—N tunneling. In this case, electrons accumulated on the floating gate are discharged into the source area, so that the memory cells have an erasing threshold voltage distribution.

Each memory cell string may have a plurality of floating gate type memory cells serially connected to each other. Access lines (sometimes called “word lines”) are extended in a row direction, and a control gate of each memory cell is connected to a corresponding access line. A non-volatile memory device may include a plurality of page buffers connected between the bit lines and the column decoder. The column decoder is connected between the page buffer and data lines.

### BRIEF DESCRIPTION OF THE DRAWINGS

FIG. 1 is a diagram illustrating an example system capable of protecting data stored on memory devices based on user behavior awareness.

FIG. 2 is a diagram of example components included in a memory device.

FIG. 3 is a diagram illustrating an example associated with protecting data stored on memory devices based on user behavior awareness.

FIG. 4 is a diagram illustrating an example associated with protecting data stored on memory devices based on user behavior awareness.

FIG. 5 is a flowchart of an example method associated with protecting data stored on memory devices based on user behavior awareness.

### DETAILED DESCRIPTION

A memory device (e.g., memory device 120) may store various types of sensitive information. Such information may be stored in various formats, such as documents, photographs, audio, video, and/or binary files. A binary file may be a compressed file or an encrypted file. Content stored on the memory device may be accessed by a user who has physical access to the memory device. The content may be protected by keeping the memory device away from malicious users.

However, the content may not necessarily be protected when a malicious user is able to access the memory device. Some approaches to protect the content from malicious users may involve encrypting the content stored on the memory device, enabling a password-based authentication on the memory device, and/or using biometrics for locking device content. For retail customers, the user may be required to select a protection mechanism and/or install a device-manufacturer-provided application within the memory device. Alternatively, for enterprise customers, content protection may be provided by a host software layer (e.g., application, access control, and/or network security).

In some implementations, the memory device may be self-aware of a type of user that is interacting with the memory device. The memory device may include embedded firmware and/or hardware, which may be used to detect an anomalous use of the memory device or an attempted anomalous use of the memory device. When the anomalous use or the attempted anomalous use is detected, the memory device may take protective action to protect content stored on the memory device (e.g., by using an increasing level of soft to hard protection techniques).

In some implementations, the memory device may be associated with a user profile, which may be created by a user of the memory device. The memory device may be associated with a profile recovery password/passphrase, which may be securely stored on the memory device. The memory device may be associated with a user behavior learning module, which may reside in a firmware of the memory device. The memory device may be associated with a firmware behavior administration module, which may reside in the firmware of the memory device. The memory device may be associated with a device locking algorithm engine, which may reside in the firmware of the memory device.

In some implementations, when the memory device is initially configured (e.g., at a start of life of the memory device), the user may set the user profile and the profile recovery password/passphrase. Thereafter, during an operation of the memory device, the user behavior learning module of the memory device may monitor and learn a behavior of the user, which may be with respect to content stored on the memory device. The user behavior learning module may be active when the memory device is powered on. The user behavior learning module may determine a usage pattern in relation to the content stored on the memory device. When an anomaly is detected in the usage pattern of the content (e.g., the anomalous use or the attempted anomalous use is detected), the device locking algorithm engine may start locking content stored on the memory device in a step-up approach. For example, various types of locking levels may be used, such as a timed lock, a staggered lock, a zoned lock, and/or a total lock. When a lock level is applied, the lock level may escalate to a next higher lock level or de-escalate to a softer lock level, depending on anomaly resolution steps taken by a user to prevent a complete lockdown.

In some implementations, the memory device may be recovered when the memory device has self-locked itself to protect the content from a potentially malicious user. For example, when the memory device becomes locked during normal operations or operations without malicious intent, the memory device may be sent to a manufacturer for data recovery. However, when the content on the memory device is encrypted, a recovery process may or may not be able to decrypt the content on the memory device.

In some implementations, a user behavior aware security mechanism may be activated for the memory device. For example, a user of the memory device may activate the user behavior aware security mechanism at no additional cost. The user behavior aware security mechanism may provide protection of data in the memory device based on user behavior awareness. The protection of data in the memory device may be achieved in an in situ manner. For example, the data may be protected without interrupting a normal state of the memory device. The user behavior aware security mechanism may provide additional security within the memory device. The user behavior aware security mechanism may provide a protection layer for unencrypted drives, no performance compromise due to encryption, and/or a second layer of protection for encrypted drives. Further, the user behavior aware security mechanism may be implemented on legacy memory devices via a firmware patch. As a result, the memory device may provide increased protection against data access by malicious users, thereby improving an overall security of the memory device.

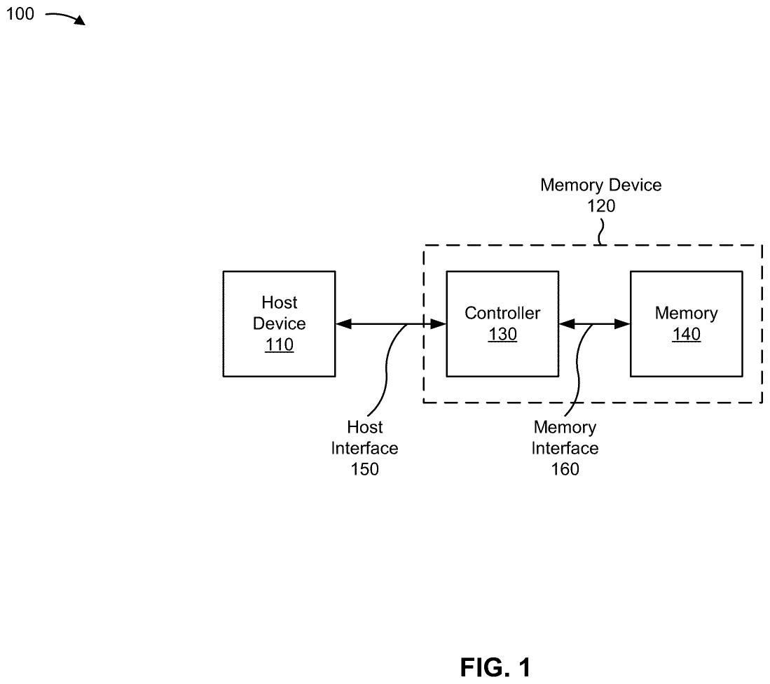

FIG. 1 is a diagram illustrating an example system 100 capable of protecting data stored on memory devices based on user behavior awareness. The system 100 may include one or more devices, apparatuses, and/or components for performing operations described herein. For example, the system 100 may include a host device 110 and a memory device 120. The memory device 120 may include a controller 130 and memory 140. The host device 110 may communicate with the memory device 120 (e.g., the controller 130 of the memory device 120) via a host interface 150. The controller 130 and the memory 140 may communicate via a memory interface 160.

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host device 110 may include one or more processors configured to execute instructions and store data in the memory 140. For example, the host device 110 may include a central processing unit (CPU), a graphics processing unit (GPU), a field-programmable gate array (FPGA), an application-specific integrated circuit (ASIC), and/or another type of processing component.

The memory device 120 may be any electronic device or apparatus configured to store data in memory. In some implementations, the memory device 120 may be an electronic device configured to store data persistently in non-volatile memory. For example, the memory device 120 may be a hard drive, a solid-state drive (SSD), a flash memory device (e.g., a NAND flash memory device or a NOR flash memory device), a universal serial bus (USB) thumb drive, a memory card (e.g., a secure digital (SD) card), a secondary storage device, a non-volatile memory express (NVMe) device, and/or an embedded multimedia card (eMMC) device. In this case, the memory 140 may include non-volatile memory configured to maintain stored data after the memory device 120 is powered off. For example, the memory 140 may include NAND memory or NOR memory. In some implementations, the memory 140 may include volatile memory that requires power to maintain stored data and that loses stored data after the memory device 120 is powered off, such as one or more latches and/or random-access memory (RAM), such as dynamic RAM (DRAM) and/or static RAM (SRAM). For example, the volatile memory may cache data read from or to be written to non-volatile memory, and/or may cache instructions to be executed by the controller 130.

The controller 130 may be any device configured to communicate with the host device (e.g., via the host interface 150) and the memory 140 (e.g., via the memory interface 160). Additionally, or alternatively, the controller 130 may be configured to control operations of the memory device 120 and/or the memory 140. For example, the controller 130 may include control logic, a memory controller, a system controller, an ASIC, an FPGA, a processor, a microcontroller, and/or one or more processing components. In some implementations, the controller 130 may be a high-level controller, which may communicate directly with the host device 110 and may instruct one or more low-level controllers regarding memory operations to be performed in connection with the memory 140. In some implementations, the controller 130 may be a low-level controller, which may receive instructions regarding memory operations from a high-level controller that interfaces directly with the host device 110. As an example, a high-level controller may be an SSD controller, and a low-level controller may be a non-volatile memory controller (e.g., a NAND controller) or a volatile memory controller (e.g., a DRAM controller). In some implementations, a set of operations described herein as being performed by the controller 130 may be performed by a single controller (e.g., the entire set of operations may be performed by a single high-level controller or a single low-level controller). Alternatively, a set of operations described herein as being performed by the controller 130 may be performed by more than one controller (e.g., a first subset of the operations may be performed by a high-level controller and a second subset of the operations may be performed by a low-level controller).

The host interface 150 enables communication between the host device 110 and the memory device 120. The host interface 150 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a universal flash storage (UFS) interface, and/or an eMMC interface.

The memory interface 160 enables communication between the memory device 120 and the memory 140. The memory interface 160 may include a non-volatile memory interface (e.g., for communicating with non-volatile memory), such as a NAND interface or a NOR interface. Additionally, or alternatively, the memory interface 160 may include a volatile memory interface (e.g., for communicating with volatile memory), such as a double data rate (DDR) interface.

In some implementations, one or more systems, devices, apparatuses, components, and/or controllers of FIG. 1 may be configured to identify an operation to access content stored in a memory of the memory device, wherein the operation is associated with a user profile; flag a user, associated with the user profile, as being potentially malicious based on the operation conflicting with a past content access pattern associated with the user profile; and lock the memory based on the user being flagged.

In some implementations, one or more systems, devices, apparatuses, components, and/or controllers of FIG. 1 may be configured to detect an operation to access content stored in a memory of the memory device, wherein the operation is associated with a user profile; flag a user associated with the user profile as being potentially malicious based on the operation conflicting with a past content access pattern associated with the user profile; and apply a locking mechanism to lock the memory based on the user being flagged, wherein subsequent access attempts associated with the user profile are blocked based on the locking mechanism.

In some implementations, one or more systems, devices, apparatuses, components, and/or controllers of FIG. 1 may be configured to identify an operation to access content stored in the memory, wherein the operation is associated with a user profile; determine that a user associated with the user profile is potentially malicious based on the operation conflicting with past learned user behavior associated with the user profile; and apply a locking mechanism to lock the memory.

As indicated above, FIG. 1 is provided as an example. Other examples may differ from what is described with regard to FIG. 1.

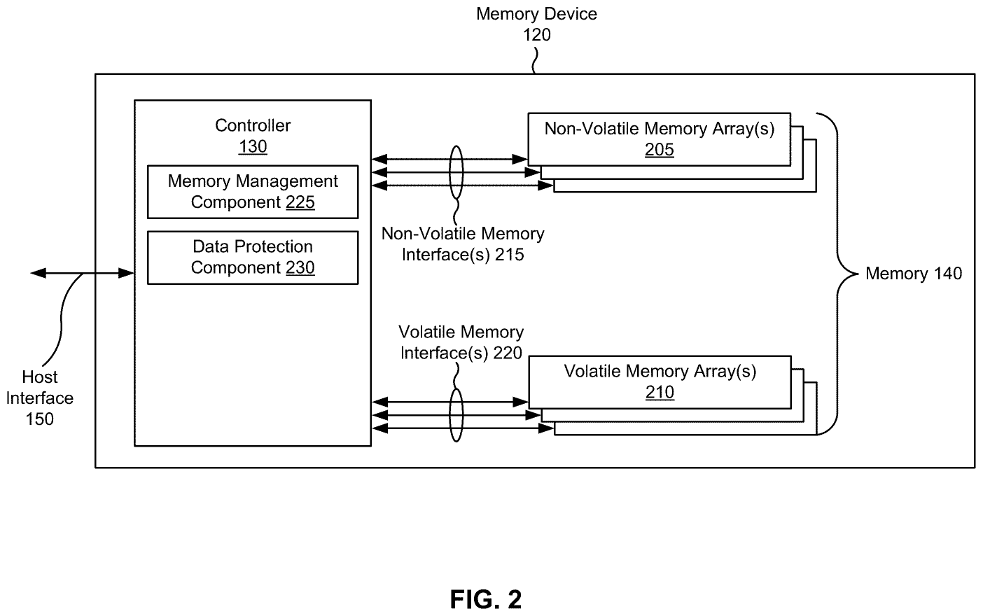

FIG. 2 is a diagram of example components included in a memory device 120. As described above in connection with FIG. 1, the memory device 120 may include a controller 130 and memory 140. As shown in FIG. 2, the memory 140 may include one or more non-volatile memory arrays 205, such as one or more NAND memory arrays and/or one or more NOR memory arrays. Additionally, or alternatively, the memory 140 may include one or more volatile memory arrays 210, such as one or more SRAM arrays and/or one or more DRAM arrays. The controller 130 may transmit signals to and receive signals from a non-volatile memory array 205 using a non-volatile memory interface 215. The controller 130 may transmit signals to and receive signals from a volatile memory array 210 using a volatile memory interface 220.

The controller 130 may control operations of the memory 140, such as by executing one or more instructions. For example, the memory device 120 may store one or more instructions in the memory 140 as firmware, and the controller 130 may execute those one or more instructions. Additionally, or alternatively, the controller 130 may receive one or more instructions from the host device 110 via the host interface 150, and may execute those one or more instructions. In some implementations, a non-transitory computer-readable medium (e.g., volatile memory and/or non-volatile memory) may store a set of instructions (e.g., one or more instructions or code) for execution by the controller 130. The controller 130 may execute the set of instructions to perform one or more operations or methods described herein. In some implementations, execution of the set of instructions, by the controller 130, causes the controller 130 and/or the memory device 120 to perform one or more operations or methods described herein. In some implementations, hardwired circuitry is used instead of or in combination with the one or more instructions to perform one or more operations or methods described herein. Additionally, or alternatively, the controller 130 and/or one or more components of the memory device 120 may be configured to perform one or more operations or methods described herein. An instruction is sometimes called a “command.”

For example, the controller 130 may transmit signals to and/or receive signals from the memory 140 based on the one or more instructions, such as to transfer data to (e.g., write or program), to transfer data from (e.g., read), and/or to erase all or a portion of the memory 140 (e.g., one or more memory cells, pages, sub-blocks, blocks, or planes of the memory 140). Additionally, or alternatively, the controller 130 may be configured to control access to the memory 140 and/or to provide a translation layer between the host device 110 and the memory 140 (e.g., for mapping logical addresses to physical addresses of a memory array). In some implementations, the controller 130 may translate a host interface command (e.g., a command received from the host device 110) into a memory interface command (e.g., a command for performing an operation on a memory array).

As shown in FIG. 2, the controller 130 may include a memory management component 225, and/or a data protection component 230. In some implementations, one or more of these components are implemented as one or more instructions (e.g., firmware) executed by the controller 130. Alternatively, one or more of these components may be implemented as dedicated integrated circuits distinct from the controller 130.

The memory management component 225 may be configured to manage performance of the memory device 120. For example, the memory management component 225 may perform wear leveling, bad block management, block retirement, read disturb management, and/or other memory management operations. In some implementations, the memory device 120 may store (e.g., in memory 140) one or more memory management tables. A memory management table may store information that may be used by or updated by the memory management component 225, such as information regarding memory block age, memory block erase count, and/or error information associated with a memory partition (e.g., a memory cell, a row of memory, a block of memory, or the like).

The data protection component 230 may be configured to identify an operation to access content stored in a memory of the memory device, wherein the operation is associated with a user profile. The data protection component 230 may be configured to flag a user, associated with the user profile, as being potentially malicious based on the operation conflicting with a past content access pattern associated with the user profile. The data protection component 230 may be configured to lock the memory based on the user being flagged.

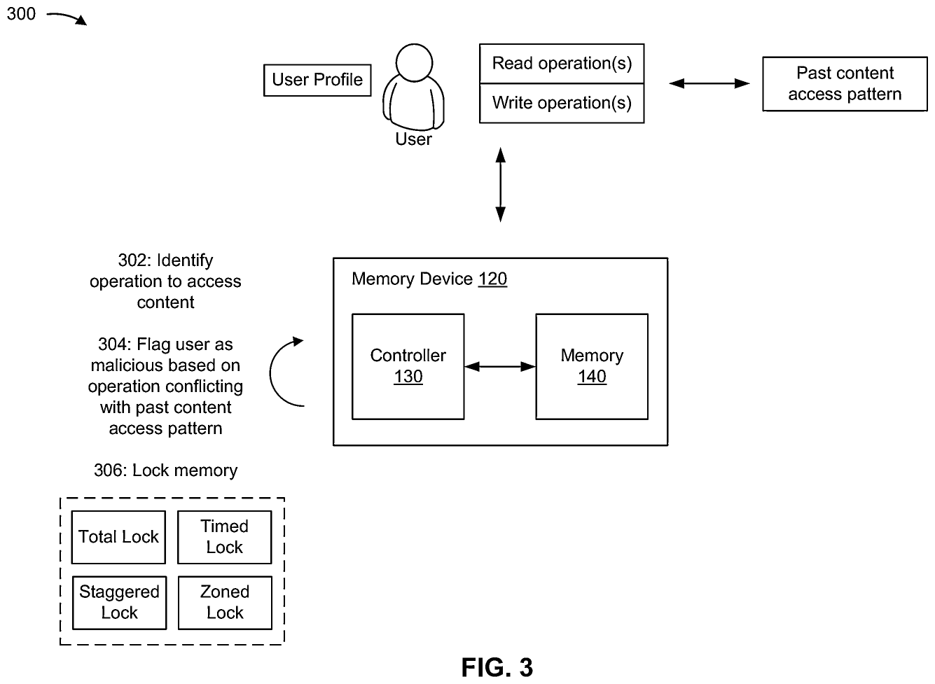

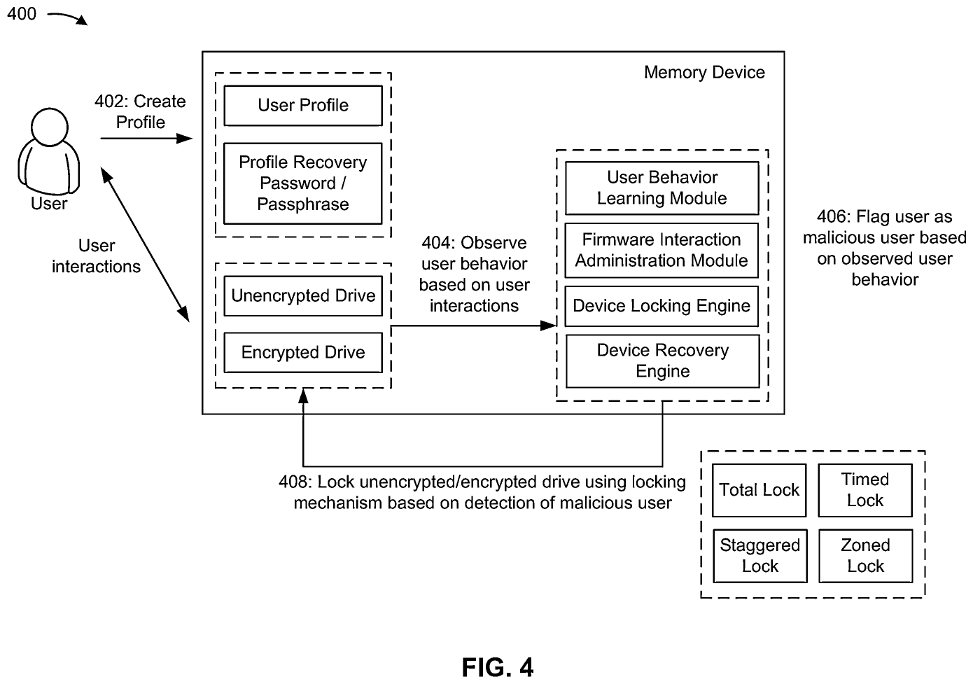

One or more devices or components shown in FIG. 2 may be configured to perform operations described herein, such as one or more operations and/or methods described in connection with FIGS. 3-4. For example, the controller 130, the memory management component 225, and/or the data protection component 230 may be configured to perform one or more operations and/or methods for the memory device 120.

The number and arrangement of components shown in FIG. 2 are provided as an example. In practice, there may be additional components, fewer components, different components, or differently arranged components than those shown in FIG. 2. Furthermore, two or more components shown in FIG. 2 may be implemented within a single component, or a single component shown in FIG. 2 may be implemented as multiple, distributed components. Additionally, or alternatively, a set of components (e.g., one or more components) shown in FIG. 2 may perform one or more operations described as being performed by another set of components shown in FIG. 2.

FIG. 3 is a diagram of an example 300 of protecting data stored on memory devices based on user behavior awareness. The operations described in connection with FIG. 3 may be performed by the memory device 120 and/or one or more components of the memory device 120, such as the controller 130 and/or one or more components of the controller 130. The operations described in connection with FIG. 3 may be performed using embedded hardware and firmware of the memory device 120.

As shown by reference number 302, the memory device 120 may identify an operation (or multiple operations) to access content stored in a memory 140 of the memory device 120. The memory 140 may be an encrypted memory or an unencrypted memory. The operation may be an operation to read content stored in the memory 140. The operation may be an operation to write content to the memory 140. The operation may be associated with a user profile, where the user profile may be associated with a user of the memory device 120. The user may be a current active user of the memory device 120. The user may initiate the operation to access content stored in the memory 140 of the memory device 120. A host device (e.g., host device 110) may send, to the memory device 120, a vendor specific command to indicate the user profile of the user. A user behavior associated with the user may be identified based on the operation. The user behavior may be indicative of a manner in which the content is typically accessed from the memory 140.

In some implementations, the user profile may indicate a username associated with the user, a user password or passphrase, a user privilege level associated with accessing content (e.g., whether the user is a normal user or an administrator), a credential expiry, and/or a selected recovery mechanism. The user profile may be stored on a secure portion of the memory device 120. The user profile may be created when the memory device 120 is initially used by the user. The operation may be identified for a current active session associated with the user. Information regarding the operation may not be retained across a reset of the memory device 120 or a power cycle of the memory device 120.

As shown by reference number 304, the memory device 120 may flag a user, associated with the user profile, as being potentially malicious based on the operation conflicting with a past content access pattern associated with the user profile. The past content access pattern may be derived from learned user behavior data, which may be gathered over a period of time for the user profile. The past content access pattern may be maintained across power cycles of the memory device 120. The learned user behavior data may indicate typical operations for accessing content stored in the memory 140 of the memory device 140. For example, the learned user behavior data may indicate typical read/write operations, types of operations (e.g., moving data), and/or areas of the memory 140 that are accessed or not accessed (e.g., portions of memory that store information associated with firmware are typically not written to or read). The learned user behavior data may be specific to the user associated with the user profile. User interactions associated with the user profile may be gathered over the period of time, where the user interactions may be associated with the content accessed from the memory 140. The memory device 120 may determine typical user interactions over the period of time. The memory device 120 may compare the operation to the past content access pattern, which may be based on the typical user interactions gathered over the period of time. When the operation is aligned with the past content access pattern, then the operation is permitted. When the operation is not aligned with the past content access pattern, then the memory device 120 may flag the user as being a potential malicious user. In other words, a user that is attempting to initiate the operation may be attempting to initiate an operation that is not typically done, by the user associated with the user profile, so the user may be considered to be potentially malicious. In this case, the user may be flagged.

In some implementations, the memory device 120 may run a machine learning model. The machine learning model may receive an indication of the operation as an input, and the machine learning model may provide an output that indicates that the user should be flagged as being potentially malicious. In other words, based on the operation, the machine learning model may predict, with a given likelihood of success, whether the operation is being initiated by a malicious user. A capability of the machine learning model may depend on resource constraints of the memory device 120. The machine learning model may be an embedded module within the firmware of the memory device 120. The machine learning model may not be associated with a host application. The machine learning model may learn statistically over time. For example, the machine learning model may count a number of deviant attempts over time, a number of system area access attempts, a number of times an attempt is continued, and so on, which may allow the machine learning model to learn the past content access pattern. The machine learning model may determine, based on the operation in relation to the past content access pattern, whether the user should be flagged as being potentially malicious.

As an example, the memory device 120 may detect, based on the operation, that the user is trying to access data from a protected zone of the memory 140. As another example, the memory device 120 may detect, based on the operation, that the user is attempting to write to the protected zone of the memory 140. As yet another example, the memory device 120 may detect, based on multiple operations, that the user is attempting to access and overwrite firmware on the memory device 120 when the user profile is not associated with an administrator level. The user may not be allowed to access a firmware region of the memory 140, which may be indicated in the user profile. The user may not be allowed to access system storage on which encrypted data is stored. The user may not be allowed to access data outside of a particular zone or partition of the memory 140. In these examples, the memory device 120 may flag the user, associated with the user profile, as being potentially malicious. Such user actions may not be aligned with the past content access pattern associated with the user profile, which may imply that a malicious user has taken control of the memory device 120 and is attempting to perform some malicious activity.

As shown by reference number 304, the memory device 120 may lock the memory 140 based on the user being flagged. The memory device 120 may apply a timed lock to lock the memory 140 for a duration of time. The memory device 120 may apply a staggered lock to lock the memory 140 with varying levels of access restrictions. The memory device 120 may apply a zoned lock to lock the user profile from accessing a secure zone of the memory 140, where the secure zone may be associated with a particular address range of the memory 140. The memory device 120 may apply a total lock to lock the memory 140, where the total lock may prevent an access associated with the user profile. As a result, the memory device 120 may lock the memory 140 to protect content stored on the memory 140. The lock may prevent the malicious user from accessing the content, thereby improving an overall security of the memory device 120. The memory device 120 may be locked based on monitored user activity, and the locking may be achieved at a command protocol level. The locking may be done within the memory device 120 without reliance on the host device.

As indicated above, FIG. 3 is provided as an example. Other examples may differ from what is described with regard to FIG. 3.

FIG. 4 is a diagram of an example 400 of protecting data stored on memory devices based on user behavior awareness. The operations described in connection with FIG. 4 may be performed by the memory device 120 and/or one or more components of the memory device 120, such as the controller 130 and/or one or more components of the controller 130.

In some implementations, the memory device 120 may include a user behavior learning module, a firmware interaction administration module, a device locking engine, and a device recovery engine. The memory device 120 may store a user profile of a user associated with the memory device 120. The memory device 120 may include one or more drives, which may include an encrypted drive and/or an unencrypted drive. The memory device 120 may be able to apply device protection lock levels based on a potential threat to the memory device 120.

As shown by reference number 402, the user profile may be created. When the memory device 120 is first used, the user may be expected to create the user profile. The user may be a current active user of the memory device 120. After the user profile is created, a status of the user may be maintained in an internal memory of the memory device 120, but such retention may not be allowed across hard resets, warm power cycles, and/or cold power cycles of the memory device 120. The user profile may be created before a drive of the memory device 120 is accessed. The user profile may be associated with a profile recovery password/passphrase, a username, a user privilege level, an optional credential expiry if any, and/or a selected recovery option. The types of information that are associated with the user profile may be based on an implementation. After the user profile is created, the user profile may be stored securely within the memory device 120 for future verification. A non-volatile secure storage may be used, where a protection of the user profile may be based on an electrical fuse (eFUSE) or a physical unclonable function (PUF). The memory device 120 may not have an embedded real time clock, so a user profile expiry may be configured using a cycles-of-use counter. In some cases, the cycles-of-use counter may span a time period of ten years or more. A counter increment may be based on the number of times that the user profile is accessed.

In some implementations, unlocking the memory device 120 to access content stored on the memory device 120 by a registered user may be counted as a single user login to the memory device 120. A user login counter may be implemented using vendor specific device access protocol commands, or an implementation may utilize an existing security-oriented protocol in a UFS protocol or a non-UFS protocol.

As shown by reference number 404, the user behavior learning module may observe user behavior based on user interactions with the one or more drives. The user may interact with the one or more drives. For example, the user may access particular content and/or particular content a certain number of times and/or at certain times of the day. After the user profile is activated, a firmware of the memory device 120 may become aware of the nature of tasks that the user is allowed to do or the nature of tasks generally performed by the user. The user behavior learning module may observe and learn user behavior (e.g., operations initiated by the current active user). All user interactions with the one or more drives may pass through the user behavior learning module. The user behavior learning module may compare observed user behavior data with past learned user behavior data. The past learned user behavior data may be maintained across power cycles. The user behavior learning module may compare the observed user behavior data to internal boundaries of allowance. The user behavior learning module may be implemented using a machine learning model (e.g., a tiny machine learning model loaded onto the memory device 120). The user behavior learning module may be within resource constraints of the memory device 120. Resource limitations may be related to a code memory size available and a size of executable RAM available for the machine learning model. When additional learning cycles are needed, the additional learning cycles may be negotiated through safety/lock protocols.

As shown by reference number 406, the user behavior learning module may detect user activity that includes an anomaly based on the observed user behavior, which may cause the user to be flagged as a potential malicious user. The anomaly may be user activity that has not been performed before, or user activity done at a certain time that conflicts with prior user activity. The user behavior learning module may generate a flag, which may indicate that further analytics are needed. The flag may be provided to the firmware interaction administration module. The firmware interaction administration module may be responsible for obtaining feedback from the user behavior learning module to detect any malicious attempts of the user. The user behavior learning module may observe user behavior based on the user profile, and when the user behavior is deviant, the user may be flagged as the potential malicious user.

As shown by reference number 408, when the firmware interaction administration module is notified by the user behavior learning module that the user is potentially malicious, the firmware interaction administration module may trigger one of the device protection lock levels. A device protection lock level may involve locking the drive, which may be based on the detection of the potential malicious user. The drive may be locked on detection of the potential malicious user. The device protection lock level may be triggered or activated based on input from the user behavior learning module. For example, when the user is trying to access data from a protected zone on the memory device 120, then a lower level of device protection lock level may be applied immediately to deter the user from attempting the access. However, no valid data may be returned to the user, in a case where the user has issued a read command. On the other hand, when the user is attempting to write to a protected zone on the memory device 120, then an access denied response may be returned to the user. As another example, when the user is repeatedly attempting to access and overwrite firmware on the memory device 120 while the user profile is not an administrator level profile, then a harder device protection lock level may be applied to the memory device 120. For example, after a threshold number of illegal attempts is exceeded, the memory device 120 may completely lock out to block even a read request to the memory device 120.

In some implementations, after a detection of a potentially malicious user, the firmware interaction administration module may trigger one of the device protection lock levels to protect content stored on the memory device 120. The device protection lock levels may be associated with various locking mechanisms, such as a timed lock, a staggered lock, a zoned lock, and/or a total lock.

In some implementations, with the timed lock, the memory device 120 may lock out the user from access for a particular time period (e.g., a cooling off period). The user may be able to resume normal operation after the time period has expired. A duration of the time period may be based on an implementation. The duration of the time period may increase gradually. For example, at a first lockout, the duration of the time period may be 8 hours. At a second lockout, the duration of the time period may be 12 hours. At subsequent lockouts, the durations of the time periods may be 16 hours and so on until 24 hours is reached. At that point, other locking mechanisms may be triggered.

In some implementations, with the staggered lock, the memory device 120 may lock out the user with increasing difficulty of access restrictions. For example, at a first malicious write attempt, the memory device 120 may allow only read-only access. After a second malicious read attempt (as the memory device 120 may already be in a read-only mode for that user profile), the memory device 120 may trigger the timed lock. When the user continues the attempt, the memory device 120 may move to the total lock.

In some implementations, with the zoned lock, the memory device 120 may lock out the user profile from accessing secure zones which are not allowed to that user profile. The memory device 120 may be pre-divided into specific zones (e.g., defined using address ranges). The user profile may be associated with an attempt to read or write data to an address range that is within a secure zone and defined to be exclusive to the user.

In some implementations, with the total lock, the memory device 120 may completely lock out the user after multiple violations of user profile privileges. The memory device 120 may be locked out for all other user profiles. Alternatively, the memory device 120 may be locked out only to a malicious user profile, which may be useful for a device recovery after the total lock. With the total lock, no requests from the malicious user profile may be fulfilled by the memory device 120. The malicious user profile may be internally blacklisted by the memory device 120. Only an administrator user profile or a manufacturer may be able to unlock the memory device 120 after revalidating the user profile.

In some implementations, the device locking engine may be responsible for applying a logical locking level to the memory device 120. The device locking engine may be a gatekeeper module for a device locking mechanism. The device locking engine may work as a lock enforcer upon the direction from the firmware interaction administration module. The enforcement effected by the device locking engine may be retained across power cycles.

In some implementations, the device locking engine may work with the device recovery engine. The device recovery engine may be activated via a vendor specific command as per an administrator user role or the manufacturer. A device recovery may involve a user profile reactivation for legitimate access. The device recovery may involve an administrator user role reactivation from the manufacturer through a master reset of the memory device 120, which may involve no loss of data. The device recovery may involve sending the memory device 120 to the manufacturer.

In some implementations, for data security and data obfuscation purposes, security techniques described herein may use vendor native cryptographic libraries which are National Institute of Standards and Technology (NIST) and Federal Information Processing Standards (FIPS) compliant. No text passphrase exchange may occur between a host device (e.g., host device 110) and the memory device 120. The username, which may determine the current active user profile, and an associated passphrase to activate the user profile may be sent by the host device to activate the user profile for a current active session. Information sent by the host device may be encrypted. Keys used for encryption and decryption may depend on selected security standards. A key exchange between the host device and the memory device 120 may be symmetric or asymmetric. In some cases, a trusted authority (TA) may be implemented by a data center administrator within a data center. The TA may be hosted within a private cloud of the data center which may allow the use of a public key infrastructure in a security implementation.

As indicated above, FIG. 4 is provided as an example. Other examples may differ from what is described with regard to FIG. 4.

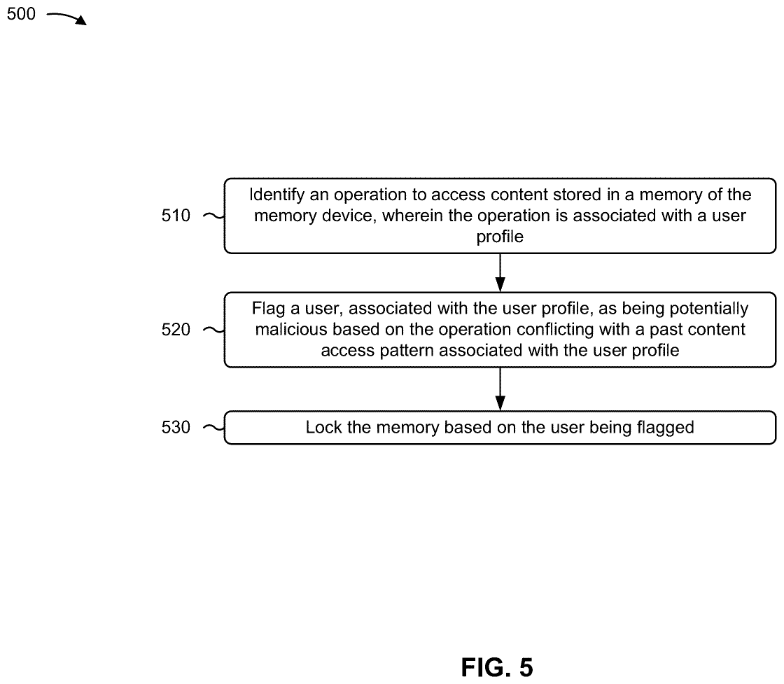

FIG. 5 is a flowchart of an example method 500 associated with the protection of data based on operations to access data content on memory devices. In some implementations, a memory device (e.g., the memory device 120) may perform or may be configured to perform the method 500. In some implementations, another device or a group of devices separate from or including the memory device (e.g., the system 100) may perform or may be configured to perform the method 500. Additionally, or alternatively, one or more components of the memory device (e.g., the controller 130, the memory management component 225, and/or data protection component 230) may perform or may be configured to perform the method 500. Thus, means for performing the method 500 may include the memory device and/or one or more components of the memory device. Additionally, or alternatively, a non-transitory computer-readable medium may store one or more instructions that, when executed by the memory device (e.g., the controller 130 of the memory device 120), cause the memory device to perform the method 500.

As shown in FIG. 5, the method 500 may include identifying an operation to access content stored in a memory of the memory device, wherein the operation is associated with a user profile (block 510). As further shown in FIG. 5, the method 500 may include flagging a user, associated with the user profile, as being potentially malicious based on the operation conflicting with a past content access pattern associated with the user profile (block 520). As further shown in FIG. 5, the method 500 may include locking the memory based on the user being flagged (block 530).

The method 500 may include additional aspects, such as any single aspect or any combination of aspects described below and/or described in connection with one or more other methods or operations described elsewhere herein.

In a first aspect, the operation is an operation to read content stored in the memory or an operation to write content to the memory.

In a second aspect, alone or in combination with the first aspect, the user profile indicates one or more of: a username associated with the user, a user password or passphrase, a user privilege level associated with accessing content, a credential expiry, or a selected recovery mechanism, and the user profile is stored on a secure portion of the memory device.

In a third aspect, alone or in combination with one or more of the first and second aspects, the past content access pattern is maintained across power cycles of the memory device.

In a fourth aspect, alone or in combination with one or more of the first through third aspects, the method 500 includes running a machine learning model onboard the memory device, the machine learning model learns the past content access pattern, the operation is provided as an input to the machine learning model, and an output from the machine learning model indicates that the user should be flagged as being potentially malicious.

In a fifth aspect, alone or in combination with one or more of the first through fourth aspects, the operation is identified for a current active session associated with the user, and information regarding the operation is not retained across a reset or a power cycle of the memory device.

In a sixth aspect, alone or in combination with one or more of the first through fifth aspects, the method 500 includes applying a timed lock to lock the memory for a duration of time.

In a seventh aspect, alone or in combination with one or more of the first through sixth aspects, the method 500 includes applying a staggered lock to lock the memory with varying levels of access restrictions.

In an eighth aspect, alone or in combination with one or more of the first through seventh aspects, the method 500 includes applying a zoned lock to lock the user profile from accessing a secure zone of the memory, wherein the secure zone is associated with a particular address range of the memory.

In a nineth aspect, alone or in combination with one or more of the first through eighth aspects, the method 500 includes applying a total lock to lock the memory, wherein the total lock prevents an access associated with the user profile.

In a tenth aspect, alone or in combination with one or more of the first through nineth aspects, the memory is an encrypted memory or an unencrypted memory, and the one or more components are implemented using embedded hardware and firmware of the memory device.

Although FIG. 5 shows example blocks of a method 500, in some implementations, the method 500 may include additional blocks, fewer blocks, different blocks, or differently arranged blocks than those depicted in FIG. 5. Additionally, or alternatively, two or more of the blocks of the method 500 may be performed in parallel. The method 500 is an example of one method that may be performed by one or more devices described herein. These one or more devices may perform or may be configured to perform one or more other methods based on operations described herein.

In some implementations, a memory device includes one or more components configured to: identify an operation to access content stored in a memory of the memory device, wherein the operation is associated with a user profile; flag a user, associated with the user profile, as being potentially malicious based on the operation conflicting with a past content access pattern associated with the user profile; and lock the memory based on the user being flagged.

In some implementations, a method includes detecting, by a controller of a memory device, an operation to access content stored in a memory of the memory device, wherein the operation is associated with a user profile; flagging, by the controller, a user associated with the user profile as being potentially malicious based on the operation conflicting with a past content access pattern associated with the user profile; and applying, by the controller, a locking mechanism to lock the memory based on the user being flagged, wherein subsequent access attempts associated with the user profile are blocked based on the locking mechanism.

In some implementations, a system includes memory; and a controller configured to: identify an operation to access content stored in the memory, wherein the operation is associated with a user profile; determine that a user associated with the user profile is potentially malicious based on the operation conflicting with past learned user behavior associated with the user profile; and apply a locking mechanism to lock the memory.

The foregoing disclosure provides illustration and description but is not intended to be exhaustive or to limit the implementations to the precise forms disclosed. Modifications and variations may be made in light of the above disclosure or may be acquired from practice of the implementations described herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A memory device, comprising:
one or more components configured to:
identify an operation to access content stored in a memory of the memory device, wherein the operation is associated with a user profile;
flag a user, associated with the user profile, as being potentially malicious based on the operation conflicting with a past content access pattern associated with the user profile; and
lock the memory based on the user being flagged.

2. The memory device of claim 1, wherein the operation is an operation to read content stored in the memory or an operation to write content to the memory.

3. The memory device of claim 1, wherein the user profile indicates one or more of: a username associated with the user, a user password or passphrase, a user privilege level associated with accessing content, a credential expiry, or a selected recovery mechanism, and the user profile is stored on a secure portion of the memory device.

4. The memory device of claim 1, wherein the past content access pattern is maintained across power cycles of the memory device.

5. The memory device of claim 1, wherein the one or more components are further configured to run a machine learning model onboard the memory device, the operation is provided as an input to the machine learning model, and an output from the machine learning model indicates that the user should be flagged as being potentially malicious.

6. The memory device of claim 1, wherein the operation is identified for a current active session associated with the user, and information regarding the operation is not retained across a reset or a power cycle of the memory device.

7. The memory device of claim 1, wherein the one or more components, to lock the memory, are configured to:
apply a timed lock to lock the memory for a duration of time.

8. The memory device of claim 1, wherein the one or more components, to lock the memory, are configured to:
apply a staggered lock to lock the memory with varying levels of access restrictions.

9. The memory device of claim 1, wherein the one or more components, to lock the memory, are configured to:
apply a zoned lock to lock the user profile from accessing a secure zone of the memory, wherein the secure zone is associated with a particular address range of the memory.

10. The memory device of claim 1, wherein the one or more components, to lock the memory, are configured to:
apply a total lock to lock the memory, wherein the total lock prevents an access associated with the user profile.

11. The memory device of claim 1, wherein the memory is an encrypted memory or an unencrypted memory, and the one or more components are implemented using embedded hardware and firmware of the memory device.

12. A method, comprising:
detecting, by a controller of a memory device, an operation to access content stored in a memory of the memory device, wherein the operation is associated with a user profile;
flagging, by the controller, a user associated with the user profile as being potentially malicious based on the operation conflicting with a past content access pattern associated with the user profile; and
applying, by the controller, a locking mechanism to lock the memory based on the user being flagged, wherein subsequent access attempts associated with the user profile are blocked based on the locking mechanism.

13. The method of claim 12, wherein the user profile indicates one or more of: a username associated with the user, a user password or passphrase, a user privilege level associated with accessing content, a credential expiry, or a selected recovery mechanism, and the user profile is stored on a secure portion of the memory device.

14. The method of claim 12, further comprising running a machine learning model onboard the memory device, the machine learning model learns the past content access pattern, the operation is provided as an input to the machine learning model, and an output from the machine learning model indicates that the user should be flagged as being potentially malicious.

15. The method of claim 12, wherein the operation is identified for a current active session associated with the user, and information regarding the operation is not retained across a reset or a power cycle of the memory device.

16. The method of claim 12, wherein locking the memory further comprises:
applying a timed lock to lock the memory for a duration of time;
applying a staggered lock to lock the memory with varying levels of access restrictions;
applying a zoned lock to lock the user profile from accessing a secure zone of the memory, wherein the secure zone is associated with a particular address range of the memory; or
applying a total lock to lock the memory, wherein the total lock prevents an access associated with the user profile.

17. A system, comprising:
memory; and
a controller configured to:
identify an operation to access content stored in the memory, wherein the operation is associated with a user profile;
determine that a user associated with the user profile is potentially malicious based on the operation conflicting with past learned user behavior associated with the user profile; and
apply a locking mechanism to lock the memory.

18. The system of claim 17, wherein the controller is further configured to run a machine learning model, the operation is provided as an input to the machine learning model, and an output from the machine learning model indicates that the user should be flagged as being potentially malicious.

19. The system of claim 17, wherein the controller, to apply the locking mechanism, is further configured to:
apply a timed lock to lock the memory for a duration of time;
apply a staggered lock to lock the memory with varying levels of access restrictions;
apply a zoned lock to lock the user profile from accessing a secure zone of the memory, wherein the secure zone is associated with a particular address range of the memory; or
apply a total lock to lock the memory, wherein the total lock prevents an access associated with the user profile.

20. The system of claim 17, wherein the memory is an encrypted memory or an unencrypted memory, and the controller is implemented using embedded hardware and firmware.
